(19) United States
(12) Patent Application Publication
(10) Pub. No.: US 2009/0136283 A1
(43) Pub. Date: May 28, 2009

(54) WRITING INSTRUMENT FOR HAND-HELD DEVICES

(76) Inventor: Jay Alexander Diamond, Atlanta, GA (US)

Correspondence Address: LAWRENCE E. LAMBELET JR., 5 BLACKWELL ROAD, FLEMINGTON, NJ, 08822, US

(21) Appl. No.: 12/271,711

(22) Filed: Nov. 14, 2008

Related U.S. Application Data
(60) Provisional application No. 60/999,646, filed on Nov. 28, 2007.

(51) Int. Cl. B43K 24/00

(52) U.S. Cl. 401/99; 29/402.01

(57) ABSTRACT

The present invention is a collapsible retractable pen for attachment to a hand-held device, such as a cell phone. The pen extends from a compact size to an extended size to provide a comfortable fit in the hand. The extension exposes, in a coordinating movement, the writing point of a retracted ink refill. The movements are governed by a system of keys and keyways between the telescoping housing components. The nested keys and keyways allow a narrow profile while providing an intuitive operational sequence. The invention includes a sheath, or alternatively a clip, for holding the pen and attaching it an object.

### CROSS-REFERENCE TO RELATED APPLICATIONS

This application claims U.S. Provisional Application No. 60/999,646, filed on Nov. 28, 2007, as a priority application.

### FIELD OF THE INVENTION

This invention relates to writing instruments and more particularly to pens attachable to a hand-held device, such as a cell phone.

### BACKGROUND OF THE INVENTION

There are instances, such as when talking on the phone or watching TV, where a need arises to jot down information. Typically, this involves searching for an instrument to write with and sometime to write on. The latter is usually accessible in such instances. One may find a scrap of paper, a margin of a book or newspaper, a napkin, or a sales receipt stored in a wallet or purse, for example, within easy reach.

The complementary writing instrument, on the other hand, although a ubiquitous item in most household environments, never seems to be conveniently located. This is particularly true when the instance occurs while moving about with a mobile personal device, such as a cell phone. A pen, for example, attachable to an object often found in one's hand, such as a cell phone, PDA, pocket calculator, TV remote, makeup case, or even a checkbook, would be a useful implement when the need for note-jotting arises.

Standard-sized pens, however, typically with a length of six inches or more, and are too bulky for such applications. A size of about half that length would be optimal for fitting within the profile of most mobile electronic devices.

U.S. Pat. No. 6,409,404 to Piech discloses a pen of such a length in a sheath attachable to a phone with an adhesive strip. Piech's pen, however, while small in size, is also inconvenient in practice. The short length does not bridge the gap between the fingertips holding the pen and the usual bracing position against the thumb-index finger crotch. Also, the pen in this instance is itself the naked refill cartridge, which lacks sufficient body and stiffness for a customary “hand feel”. What is needed is a grippable barrel that can be extended to a comfortable cradling position in the hand.

U.S. Design Pat. D438,564 to Green illustrates what appears to be a telescopically collapsible pen in a holder attached to a cell phone. While the telescoping mechanism would conceptually provide extension sufficient for a holding position as described above, it appears that the tip end of the pen remains exposed. This not only provides the potential for the ink to dry out, but also presents the hazard of accidentally marking something. A desirable improvement would be for the tip of the pen to retract within the pen housing for protection during the collapse of the structure, and extend for use simultaneously with the extension thereof.

Such a means for bilateral collapse and extension is provided in one embodiment by U.S. Pat. No. 6,273,627 to Mittersinker. Mittersinker teaches that a cam postured laterally inside a pen casing is turned to a longitudinal posture, thereby camming a refill cartridge outwardly by the sliding extension of a casing component. Because the lateral posture of the cam must comprehend the length of an arm of the cam providing the extension distance, the body of the casing must be necessarily bulky in girth. Such a bulk would be incompatible with the size of a cell phone, for example.

A collapsible and retractable pen, which is, at once, sufficiently small in both breadth and length to fit on a cell phone as other than an unwieldy appendage thereto, and sufficiently expandable as to provide a comfortable and pleasingly substantial feel in the hand of a user, is absent in the prior art.

### SUMMARY OF THE INVENTION

In view of the above-mentioned unfulfilled needs, the present invention embodies, but is not limited by, the following objects and advantages:

A first object of the invention is to provide a readily-accessible ball point pen having a refill in a barrel to accompany a hand-held device, such as a cell phone.

A second object of the invention is to provide a means for collapsing the barrel structure to a length of substantially three inches or less.

A third object of the invention is to provide a means for retracting the pen refill into the protection of the barrel.

A fourth object of the invention is to provide a means for extending the pen to a comfortable gripping length while also extending the refill from within the barrel.

A fourth object of the invention is to maintain a girth dimension of a half inch or less.

A fifth object of the invention is to provide a means to assemble and disassemble the pen barrel to provide access to the refill for replacement purposes while, at the same time, preventing inadvertent disassembly.

A sixth object of the invention is to provide an operating means for all functionalities which is essentially “goof-proof”.

A seventh object of the invention is to provide a means for attaching a collapsible and retractable pen to a hand-held device, such as a cell phone.

In a preferred embodiment, the pen of the present invention is comprised of two telescoping, essentially tubular, components. The first tubular component, the barrel, houses a ballpoint ink refill with a coaxially disposed spring. The spring biases the refill from a base on the barrel to a retracted position within. The second tubular component, the plunger, essentially surrounds the refill and spring and travels on a parallel axis from a collapsed to an extended position by sliding within the barrel.

The travel of the plunger is restricted by a plurality of keys and keyways. The keyways, positioned in the inner wall of the barrel, have both longitudinal and transverse extent. The longitudinal, or translational, keyways permit the telescoping of the plunger with respect to the barrel, and the transverse, or rotational, keyways move the barrel and plunger into an interlocking position relative to one another. One particular set of rotational keyways moves the plunger eccentrically with respect to the barrel, thereby shifting the lateral position of the plunger with respect to the refill. One particular translational keyway separates the barrel and plunger for servicing of the ink refill.

The plunger is provided with a pair of keys, essentially oppositely disposed on the outer surface thereof, which ride in the keyways and traverse the barrel in a manner proscribed by the layout of the paths. The two keys are different is size so that the travel is further limited by a match of key and path. In fact, the system provides only one degree of freedom at each juncture of travel and, in so doing, eliminates any possibility of making a mistake.

The plunger is also provided with a pawl on the inner surface thereof. The pawl functions to engage the top of the refill when the axis of eccentricity of the plunger is shifted to a position overlapping the refill. The plunger is thus enabled to extend the refill by a short plunging stroke.

Locking positions are provided in the key and keyway system, both at the end of the plunging stroke and at the fully collapsed position, to secure the operating and storage configurations. A disassembly position is also provided by the key and keyway system. In this case, a purposeful maneuver of the components is required to avoid unintentional separation.

Another aspect of the preferred embodiment is the provision of a sheath to house the collapsible retractable pen. One side of the sheath is flat to provide a surface for attaching an adhesive means, such as double-faced tape, to bond the sheath to the hand-held device.

In an alternate embodiment, a clip is provided to hold the collapsible retractable pen in place of the sheath. The clip also has a flat surface for adhesively attaching the pen to a hand-held device of choice.

The method of using the preferred embodiment begins with the collapsed and retracted position and ends with the fully extended position. The method of collapsing is the reverse procedure. The extension procedure includes the steps: Turning the plunger counterclockwise until stopped to unlock; pulling the plunger up until stopped to extend; turning the plunger counterclockwise again until stopped to cam the barrel to an eccentric position with the pawl extending over the top of the ink refill; pushing the plunger and ink refill down until stopped to compress the spring and expose the writing point; and turning the plunger clockwise until stopped to lock the new configuration. In the collapsing procedure, the retraction of the ink refill becomes facilitated by the spring.

The method of disassembling the plunger from the barrel to change the refill includes the steps: Turning the plunger counterclockwise until stopped to unlock; pulling the plunger up until stopped to extend; pushing the plunger back down with a slight clockwise twisting pressure until the plunger slips clockwise until stopped; and lifting the plunger free from the outer barrel. The assembly steps are essentially the reverse procedure.

### DESCRIPTION OF THE DRAWINGS

Various other objects, features and attendant advantages of the present invention will become fully appreciated as the same becomes better understood through the accompanying drawings, in which like reference characters designate the same or similar parts throughout the several views, and wherein:

FIG. 1 is a perspective view of the collapsible retractable pen in a collapsed position;

FIG. 2 is a perspective view of the collapsible retractable pen in an extended position;

FIG. 3 is an exploded view in perspective of the components of the collapsible retractable pen;

FIG. 4 is a perspective view of the barrel from the top showing one of the two camming keyways;

FIG. 5 is a perspective view of the barrel from the top at a different angle to show the other camming keyway;

FIG. 6 is a perspective sectional view along C-C of FIG. 5;

FIG. 7 is a sectional view along A-A of FIG. 1 showing the components in a collapsed position;

FIG. 8 is a sectional view along B-B of FIG. 2 showing the components in an extended position;

FIG. 9 is a perspective view of the plunger showing the dissimilar keys;

FIG. 10 is a perspective view of the plunger from the bottom showing the pawl;

FIG. 11 is a perspective view of the collapsible retractable pen inserted in the sheath;

FIG. 12 is a perspective view of the collapsible retractable pen held in the clip.

### DETAILED DESCRIPTION OF THE PREFERRED EMBODIMENT

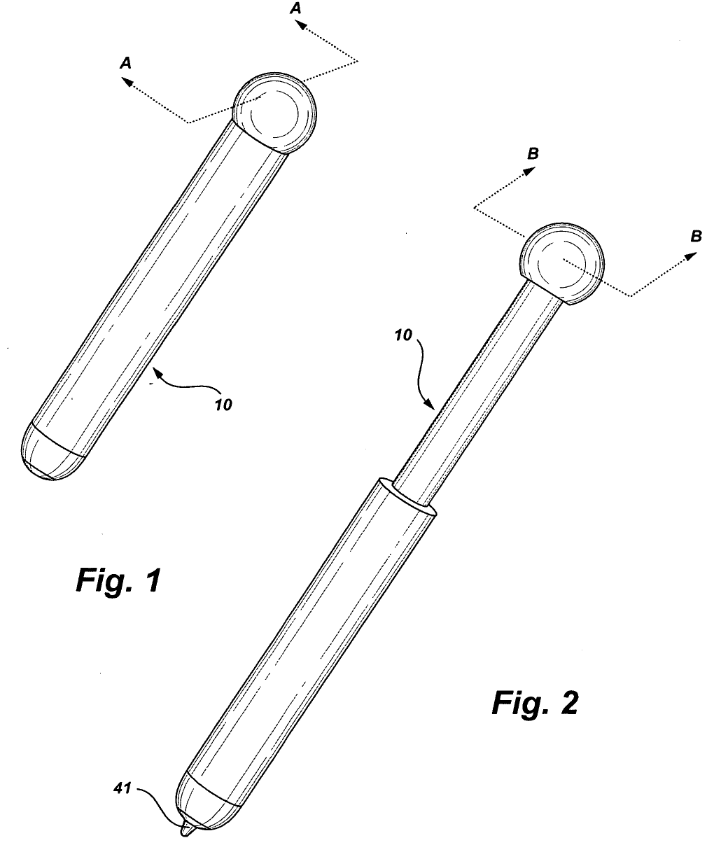

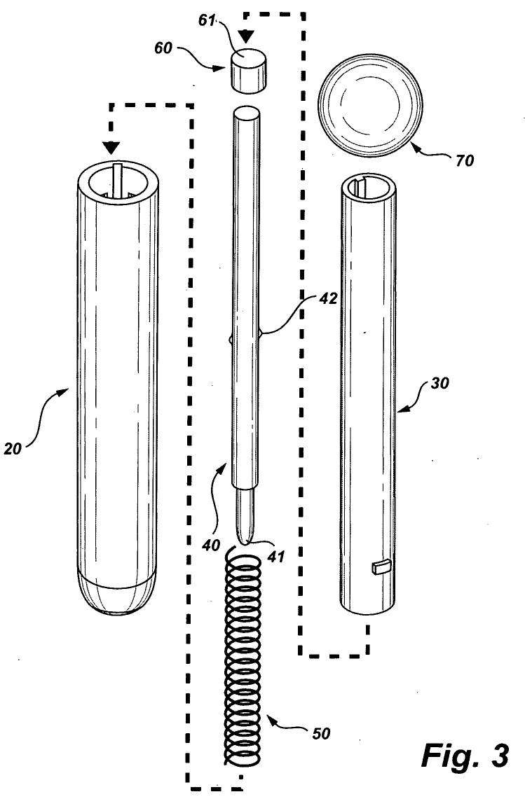

The collapsible retractable pen of the present invention, hereinafter pen 10, is shown in a collapsed configuration in FIG. 1 and in an extended configuration in FIG. 2. The various components of pen 10 are shown in the exploded view of FIG. 3. By way of assembly, ink refill 40 is inserted into spring 50 and the refill-spring sub-assembly is inserted into barrel 20. Plunger 30 is inserted over ink refill 40 and spring 50 within barrel 20 such that the refill-spring sub-assembly resides within the plunger. The ink refill is lidded with refill cap 60 and the plunger with plunger cap 70. The completed assembly is best shown in the sectional view of FIG. 8.

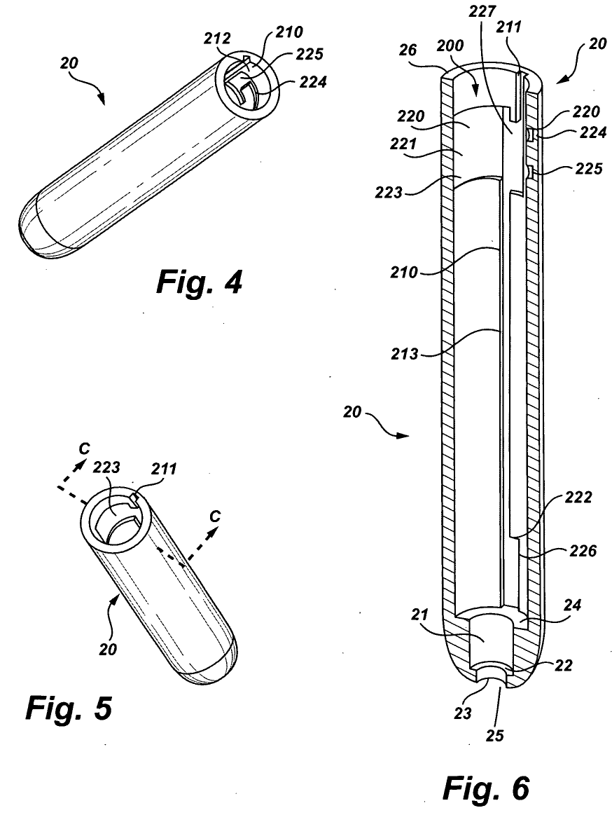

FIGS. 4-6 further illustrate barrel 20. Barrel 20 is essentially a tubular housing having a length not exceeding three inches and girth not exceeding one-half inch. It is of unitary construction, preferably molded. Barrel 20 necks to a narrowed orifice 23 at its proximal end 25. The distal end 26 of barrel 20 is essentially open. Barrel 20 additionally has a network of keyways 200 (the keyways will be discussed in a following passage) recessed in the inner wall thereof.

Referring to FIG. 6, spring 50 (FIG. 3) is inserted into spring recess 21 in the barrel and is supported thereon by spring ledge 22. Spring recess 21 holds the spring in coaxial alignment with the barrel. Spring 50 is of the steel-coil type commonly used with ballpoint pens. One or more spring lugs 42 on ink refill 40 (FIG. 3) rests on the top of spring 50 in assembly. The length of spring 50 and the location of spring lugs 42 are such that writing point 41 of the ink refill is retracted within barrel 20 when the spring is relaxed. The spring holds the ink refill in coaxially alignment.

Ink refill 40 is of the common ballpoint pen type found at many merchandisers and, particularly, at office supply stores. Refills of this type are available as replacement ink supplies and are essentially generic in form. Ink refill 40 is customized by cutting the ink reservoir to a preferred size, nominally two and half inches. Because the ink reservoir is generally comprised of plastic tubing, this is easily done with a pair of scissors. The lugs 42, which typically are formed by pinching the tubing, are standard issue. Refill cap 60 is frictionally fit over the cut end of ink refill 40 to prevent leakage of the ink. Refill cap 60 also functions to provide a dimensionally consistent shape for interaction with the plunger.

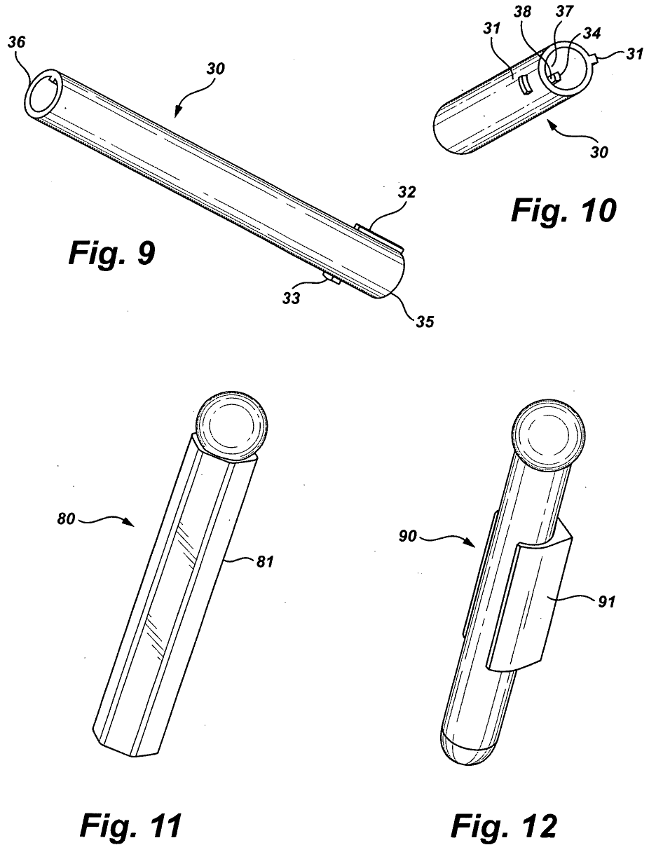

FIGS. 9 and 10 further illustrate plunger 30. Plunger 30 is essentially tubular in form and of unitary construction, preferably molded. A pair of keys 31 extends radially outward from the outside surface of plunger 30 at or near the proximal end 35 thereof. The extension of keys 31 is substantially equal to the depth of keyways 200, within which keys 31 are slidingly interposed when assembled thereto. Plunger 30 also has pawl 34 extending radially inward by an equivalent distance from the inside surface of plunger 30. The pawl 34 has an outside surface 38 which defines a free space inside plunger 30 substantially equivalent to the diameter of spring 50. The pawl 34 additionally has a proximal end 37 located so as to be at the level of the retracted refill cap top surface 61 when the plunger is fully extended from the barrel, as best shown in FIG. 8.

Plunger 30 is additionally provided with plunger cap 70 fitted to plunger distal end 36. Plunger cap 70 serves the cosmetic purpose of closing the open end and serves the functional purpose of providing a means for gripping and manipulating the plunger. Plunger cap 70 is preferably adhesively attached to plunger 30, but such methods as screw-threading, welding, or other known techniques for attaching, are alternatives.

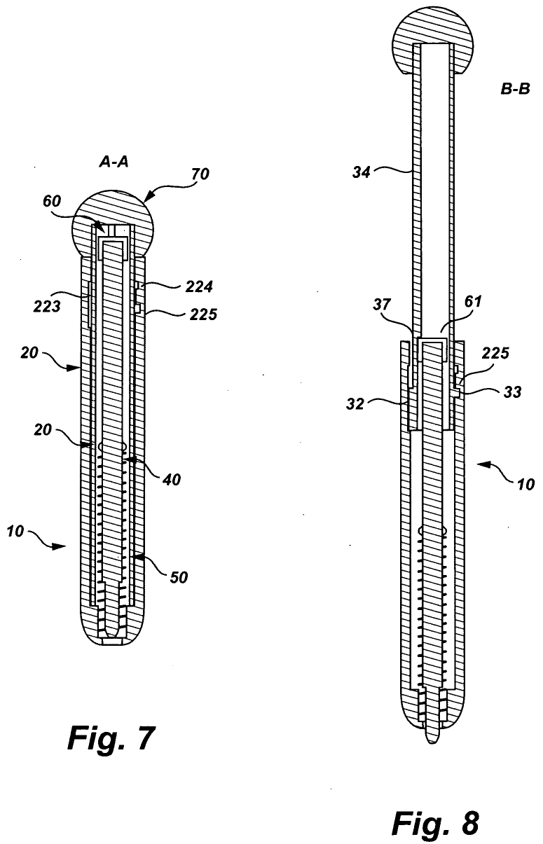

The keys 31 are of dissimilar shape and size. Key 32 is tall and narrow while key 33 is short and wide. These features match similarly shaped and dimensioned keyways 200. The short and wide features prevent the assembly of, and relative movement between, the plunger and the barrel in any other than a proscribed way. It is useful for at least one of the keys to be tall, in order to reduce wobble of the plunger when extended, and for the other to be short, so as to permit a short stroke distance. Keys 32 and 33 are positioned oppositely on a diameter that is collinear with pawl 34. Except as noted in the discussion of camming below, only one of keys 31 will be in interposition with keyways 200 at any one time, the other of keys 31 being positioned at the inner wall surface of barrel 20. This gives rise to an eccentric posture of plunger 30 with respect to barrel 20, such that the axis of the plunger is offset from the axis of the barrel on the diameter of co-linearity, on which the keys and the pawl are aligned, by a distance equivalent to a keyway depth. FIG. 8 illustrates the eccentric posture while FIG. 7 shows a non-eccentric perpendicular view.

The movement of the plunger within the barrel is governed by the keys interacting in the keyways along proscribed routes, or paths. Returning to FIGS. 4-6, keyways 200 are divided into translational keyways 210 and rotational keyways 220. Translational keyways 210 provide the means for moving plunger 30 in and out of barrel 20. Rotational keyways 220 provide, in a counterclockwise sense, the means for shifting the eccentricity of plunger 30 with respect to barrel 20, or, in a clockwise sense, the means for locking the plunger 30 in place with respect to barrel 20. The purpose for the eccentricity shift is to move the pawl 34 into position over the refill 49 so that the plunger is in place to urge the refill downwardly in a motion exposing the writing point 41 through the orifice 23.

Accordingly, there are camming keyways 221 and locking keyways 222. Tall camming keyway 223, best shown in FIG. 5, accepts tall narrow key 32 and moves it in rotational progression through continuously diminishing depth to the inner wall surface of the barrel. At the same time, diametrically-opposite short camming keyway 224, best shown in FIG. 4, receives short wide key 33 and moves it simultaneously from the wall surface into continuously increasing depth. This counterclockwise camming rotation shifts the eccentricity of the members and places the pawl proximal end 37, previously free of interference for travel, over the refill cap top surface 61. From this position, short wide key 33 can be translated a short distance downward by means of wide keyway 212, best shown in FIG. 4, and into a locking position in upper locking keyway 225 by performing a clockwise twist, best shown in FIG. 8.

Plunger proximal end 35 is assembled to barrel distal end 26 by threading the tall narrow key 32 into exit keyway 211. Exit keyway 211 is offset from narrow keyway 213. Narrow keyway 213 routes the plunger for extension by translating it up and down. The purpose of the offset is to prevent accidental disassembly. Exit keyway 211 communicates with narrow keyway 213 by means of connecting keyway 227. Connecting keyway 227 can only be accessed by applying a clockwise twisting pressure while forcing the plunger up or down. Otherwise, tall narrow key 32 bypasses connecting keyway 227 and continues on to the extended position defined by the upper end of narrow keyway 213. The collapsed position is achieved by pushing the plunger downward with tall narrow key 32 riding in narrow keyway 213 until plunger 30 is seated against plunger ledge 24. From that position, tall narrow key 32 can be rotated to a locked position by performing a clockwise twist into lower locking keyway 226.

With the exception of exit keyway 211, which is open to the top, there are abutting sidewalls at all junctures between translational keyways 210 and rotational keyways 220 and at the end of locking keyways 222. Thus it can be seen that each path has an abutment stop and only option for continuing on at each stop. In this manner, the network of keys and keyways prevents wrong-way operation while avoiding reliance upon operating instructions.

Referring to FIGS. 11 and 12, pen 10 is shown with two means for attachment to a hand-held device, such as a cell phone. Sheath 80 provides a housing into which pen 10 can be inserted and held therein with frictional fit. Venting air during insertion can escape through a hole in the bottom (not shown), or by a polygonal shape, as shown in FIG. 14, where the vertices provide interstitial spaces. Sheath 80 has at least one flat side 81 to support a means to adhesively secure the sheath to a host object, such means including double-faced tape, adhesively-backed hook-and-loop fasteners, or any other known means for attachment. In an alternative embodiment, shown in FIG. 15, clip 90 is provided for an attachable holder. Clip 90 also has a flat side 91 to support an adhesive means.

In a preferred embodiment, the barrel 20, plunger 30, refill cap 60 and plunger cap 70 are injection molded with thermoplastic materials. The material of choice would have a degree of toughness in addition to hardness for durability. Polypropylene and impact polystyrene are readily available and economical choices having these properties, but numerous other resins would be suitable, including polyolefins and recycled blends. The barrel could be molded in two halves in a family mold and subsequently joined post-molding by such means as ultrasonic welding. Alternatively, it could be molded in a traditional identical-cavity mold with a collapsible core. The other components would present little challenge to moldability.

It is to be understood that the invention is not limited in its application to the details of construction and to the arrangements of the components set forth in the above description or illustrated in the drawings. The invention is capable of other embodiments and of being practiced and a carried out in various ways. Also, it is to be understood that the phraseology and terminology employed herein are for the purpose of the description and should not be regarded as limiting.

What is claimed is:

1. A collapsible retractable pen, comprising:
an essentially tubular pen barrel having a proximal end with an orifice and a distal end;
an essentially tubular plunger slidingly fitted to the barrel at the distal end wherein it can move telescopically between a collapsed position and an extended position, the barrel and plunger configuring a housing collapsible to a preferred size;
an ink refill residing in a retracted position within the housing, the ink refill having a writing point;
a means for reversibly advancing the ink refill to expose the writing point through the orifice by extension of the plunger, whereby the pen is in position to write and the housing is provided sufficient length for cradling the pen in a hand.

2. The collapsible retractable pen of claim 1, wherein the means for reversibly advancing is the interposition of keys on the plunger with keyways in the barrel, the keys and keyways sharing a means for directing translational movement of the plunger with respect to the barrel, a means for additionally directing rotational movement therebetween, and a means for connecting the plunger to the pen refill to facilitate a plunger stroke resulting in exposing the writing point and compressing a spring to bias retraction.

3. The collapsible retractable pen of claim 2, wherein the means for directing translational movement is at least one translational keyway having an abutment representing a keyway juncture at least one end thereof.

4. The collapsible retractable pen of claim 3, wherein the means for directing rotational movement is at least one rotational keyway having an abutment representing a keyway juncture, or a stop, at least one end thereof.

5. The collapsible retractable pen of claim 4, wherein the means for connecting the plunger to the ink refill is a shift from a first eccentric position of the plunger with respect to the barrel and pen refill to a second eccentric position, the shift a result of a pair of camming rotational keyways biasing a pair of engaging keys laterally, where at the second eccentric position a pawl extending inwardly from the plunger comes in contact with the top of the ink refill, the pawl having free travel in the first eccentric position.

6. The collapsible retractable pen of claim 4, further comprising a means for assembling and disassembling the plunger and barrel.

7. The collapsible retractable pen of claim 6, wherein the means for assembling and disassembling is one translational keyway with an open end toward the distal end of the barrel, the other end having an abutment, and a rotational keyway joining at the abutment and connecting to a second translational keyway having access to the interior.

8. The collapsible retractable pen of claim 6, further comprising a means for reducing all movements to one degree of freedom, whereby wrong-way operational procedure is prevented.

9. The collapsible retractable pen of claim 8, wherein the means for reducing all movements to one degree of freedom comprises keys and keyways with matched dimensions in permissible routes, abutments at the end of each route, and only one route leading to further permissible action from each abutment.

10. The collapsible retractable pen of claim 1, wherein the preferred size is less than three inches.

11. The collapsible retractable pen of claim 1, further comprising a sheath to slidingly contain the pen, the sheath having a flat surface to support an adhesive attachment to a hand-held device.

12. The collapsible retractable pen of claim 1, further comprising a clip to grippingly contain the pen, the clip having a flat surface to support an adhesive attachment to a hand-held device.

13. A method of using the collapsible retractable pen of claim 5, comprising the steps of:
rotating the plunger counterclockwise until stopped at an abutment, thereby to unlock;
pulling the plunger upward until stopped at an abutment, thereby to extend;
rotating the plunger counterclockwise until stopped at an abutment, thereby to cam the plunger eccentrically to a position where the pawl contacts the ink refill;
pushing the plunger while in contact with the ink refill downward until stopped at an abutment, thereby to extend the writing point and compress the spring;
rotating the plunger in contact with the ink refill clockwise until stopped at an abutment, thereby to lock the operating position where the pen may be comfortably used for writing; and
reversing the above steps to collapse the plunger within the barrel and retract the ink refill by spring action.

14. A method of changing the ink refill of the collapsible retractable pen of claim 5, comprising the steps of:
rotating the plunger counterclockwise until stopped at an abutment, thereby to unlock;
pulling the plunger upward until stopped at an abutment, thereby to extend;
pushing the plunger downward with the application of clockwise pressure until the joining rotational keyway is accessed, thereby to slip laterally to an abutment stop at the juncture with the exiting keyway;
pulling the plunger upward, thereby to remove it from barrel;
exchanging the ink refill by withdrawing the old and inserting the new into the barrel and through the spring; and
reversing the above steps, thereby to collapse and lock the plunger in place with the new ink refill enclosed.
